(19) United States
(12) Patent Application Publication
(10) Pub. No.: US 2022/0095622 A1
(43) Pub. Date: Mar. 31, 2022

(54) Application of Compounds Inhibiting Synthesis of Very Long Chain Fatty Acids in Preventing and Treating Microbial Pathogens and Method Thereof

(71) Applicant: Sichuan Agricultural University, Chengdu (CN)

(72) Inventors: Xuewei Chen, Chengdu (CN); Min He, Chengdu (CN); Jia Su, Chengdu (CN); Youpin Xu, Chengdu (CN); Jinhua Chen, Chengdu (CN); Weitao Li, Chengdu (CN); Jing Wang, Chengdu (CN); Junjie Yin, Chengdu (CN); Xiaobo Zhu, Chengdu (CN)

(21) Appl. No.: 17/518,852

(22) Filed: Nov. 4, 2021

Related U.S. Application Data
(63) Continuation of application No. PCT/CN2019/107435, filed on Sep. 24, 2019.

(30) Foreign Application Priority Data
May 13, 2019 (CN) 2019103929830

(51) Int. Cl. A01N 47/16; A01N 37/22

(52) U.S. Cl. CPC A01N 47/16; A01N 37/22

(57) ABSTRACT

An application and a method of compounds inhibiting synthesis of very long chain fatty acids (VLCFAs) in preventing and controlling microbial pathogens are provided, which relate to the technical field of plant pathology and plant disease prevention and control. In particular, an application method of a compound for inhibiting the synthesis of VLCFAs in preventing and treating microbial pathogens is provided. Research results associated with the methods show that taking the synthesis of VLCFAs as the target, microbial pathogens can be inhibited by using compounds that inhibit the synthesis of VLCFAs. Therefore, the compounds inhibiting the synthesis of VLCFAs can be used in preventing and treating microbial pathogens diseases, which provides a new idea or strategy for the prevention and treatment of microbial pathogens diseases, and provides more choices for the types of drugs for the prevention and treatment of pathogenic diseases.

### CROSS-REFERENCE TO RELATED APPLICATION

This application claims the priority of the Chinese patent application No. 201910392983.0 filed in China National Intellectual Property Office on May 13, 2019, and entitled “Application of Compounds Inhibiting the Synthesis of Very Long Chain Fatty Acids in Preventing and Treating Microbial Pathogens and Method Thereof”, the entire content of which is incorporated in this application by reference.

### TECHNICAL FIELD

The invention relates to the technical field of plant pathology and plant disease prevention and control, in particular to an application and a method of compounds inhibiting the synthesis of Very Long Chain Fatty Acids (VLCFAs) in preventing and controlling microbial pathogens.

### BACKGROUND

Plant diseases seriously endanger food production and human health worldwide. For instance, rice blast, known as “rice cancer”, seriously threatens the yield and quality of rice, which occurs in rice planting areas all over the world. In severe cases, the yield of rice can be reduced by 40%-50% or even no harvest. In addition to harming rice, rice blast can also cause diseases to many important crops such as wheat and barley. In order to ensure food production safety, human and ecological health, it is urgent to develop methods and strategies for disease prevention and control.

### SUMMARY

One purpose of the invention is to provide an application of compounds inhibiting the synthesis of VLCFAs in preventing and controlling pathogenic fungi.

The other purpose of the invention is to provide a method for preventing or treating plant infection by microbial pathogens.

Chemical drug prevention is the main method to prevent microbial pathogens. The targets of traditional fungicidal drugs mainly include important enzymes related to cell wall synthesis, synthetases of key components such as sterol and sphingomyelin in cell membrane, tubulin assembly, enzymes related to branched chain amino acid synthesis, and synthetic machines of protein and nucleic acid, etc. As a microorganism, pathogenic fungihave the characteristics of easy variation, rapid reproduction and strong adaptability. Long-term use of a single antibacterial drug will easily lead to the accumulation of drug resistance of microbial pathogens, resulting in a decline in prevention and control effect. Developing important drug targets, designing and screening new fungicidal agents is of important theoretical significance and application value for comprehensive prevention and control of microbial pathogens.

VLCFAs are important lipids, which play an important role in the growth and development of some plants (such as Gramineae weeds, broadleaf weeds, etc.). In view of the importance of VLCFAs to the growth and development of some plants, their synthetic way has been used as an important herbicide target, which is widely used to prevent weeds in the field during the production of crops such as rice, wheat and corn. There are many kinds of herbicides for the biosynthesis of VLCFAs, including thiocarbamate herbicides Molinate, Diallate, Pebulate, Butylate, Sulfallate and Trialater, etc, and amide herbicides, such as Metazachlor, Butachlor, Propachlor, Cafenstrole, Flufenacet, Acetochlor, Metolachlor, etc.

Herbicides targeting very-long-chain fatty acids play an important role in preventing gramineous weeds and broad-leaved weeds. However, the research results of the invention show that taking the synthesis of very-long-chain fatty acids as the target, by using compounds that inhibit the synthesis of very-long-chain fatty acids, such as common herbicides, the prevention and control of microbial pathogens can be realized. Therefore, the compounds inhibiting the synthesis of VLCFAs can be used as fungicidal agents in the prevention of microbial pathogens, which provides a new idea or strategy for preventing and treating plant diseases such as pathogen infection, and also provides more choices for the types of drugs for preventing and treating plant diseases.

Based on the above description, on one hand, the invention provides the application of compounds inhibiting the synthesis of VLCFAs in preventing and treating microbial pathogens.

The invention provides a compound for inhibiting the synthesis of VLCFAs, which is used for preventing and treating microbial pathogens.

The research results of the invention show that the compounds inhibiting the synthesis of VLCFAs can inhibit the formation of penetration pegs when microbial pathogensinfect the epidermis of hosts by inhibiting the synthesis of VLCFAs of microbial pathogens, thereby destroying the pathogenicity of pathogenic fungiand preventing and treating diseases. Therefore, compounds that inhibit the synthesis of VLCFAs can be used for preventing and controlling microbial pathogens.

In some embodiments of the invention, VLCFAs are fatty acids with a carbon chain length of more than 20 carbon atoms.

The research of the invention further finds out that fatty acids with carbon chain length of more than 20 carbon atoms have an important influence on the pathogenicity of microbial pathogens. By inhibiting the synthesis of fatty acids with more than 20 carbon atoms in microbial pathogens, the pathogenicity is reduced and the effect of inhibiting microbial pathogens is achieved.

In some embodiments of the invention, the compounds are thiocarbamates or amides.

In some embodiments of the invention, the thiocarbamate compounds are selected from any one or a combination of Molinate, Diallate, Pebulate, Butylate, Sulfallate and Trialater.

In some embodiments of the invention, the amide compounds are selected from any one or a combination of Metazachlor, Butachlor, Propachlor, Cafenstrole, Flufenacet, Acetochlor, Metolachlor.

In some embodiments of the invention, the pathogens are pathogenic fungi.

In some embodiments of the invention, the pathogenic fungi are plant pathogenic fungi or animal pathogenic fungi.

In some embodiments of the invention, the plant pathogenic fungi are Magnaporthe oryzae, Bipolaris maydis or Blumeria graminis.

In some embodiments of the invention, the animal pathogenic fungus is Metarhizium anisopliae.

On the other hand, the invention provides a method for controlling microbial pathogens, which comprises: applying a compound having a property of inhibiting the synthesis of VLCFAs to an object to be controlled.

In some embodiments of the invention, VLCFAs are fatty acids with a carbon chain length of more than 20 carbon atoms.

In some embodiments of the invention, the compounds are thiocarbamates or amides.

In some embodiments of the invention, the thiocarbamate compounds are selected from any one or a combination of Molinate, Diallate, Pebulate, Butylate, Sulfallate and Trialater.

In some embodiments of the invention, the amide compounds are selected from any one or a combination of Metazachlor, Butachlor, Propachlor, Cafenstrole, Flufenacet, Acetochlor, Metolachlor.

In some embodiments of the invention, the pathogens are pathogenic fungi.

In some embodiments of the invention, the pathogenic fungi are Magnaporthe oryzae, Bipolaris maydis or Blumeria graminis.

In some embodiments of the invention, the object to be prevented is a plant.

In some embodiments of the invention, the plant is rice, corn or wheat.

In some embodiments of the invention, the effective control dose of the compound is 1-2 g of the compound per 100 m² of target area.

In some embodiments of the invention, the compound is sprayed in the following manner: 1-2 g of the compound is dissolved in 4 mL of dimethyl sulfoxide (DMSO), then the DMSO-dissolved compound is dissolved in 2 L of water, and the final concentration of the compound is 500-1000 μmol/L (micromoles per liter), and the aqueous solution is sprayed on the target area.

The target area refers to the planting area where crops need to be cultivated for fungal prevention.

In some embodiments of the invention, the compound is administered at a concentration of 500 μmol/l.

When the application concentration of the compound is 500 μmol/L, the inhibition rate of the compound on the pathogenicity of pathogenic fungi can reach more than 50%.

The invention provides a method for controlling microbial pathogens, which comprises the following steps:

1) preparing a compound with the characteristic of inhibiting the synthesis of VLCFAs into a solution to be applied;

2) applying the solution to an object to be prevented.

In some embodiments of the invention, dimethyl sulfoxide is used as a solvent.

### BRIEF DESCRIPTION OF THE FIGURES

In order to explain the technical scheme of the embodiments of the invention more clearly, the following drawings which need to be used in the embodiments will be briefly introduced. It should be understood that the following drawings only show some embodiments of the invention, so they should not be regarded as limiting the scope. For ordinary technicians in this field, other related drawings can be obtained according to these drawings without paying creative labor.

FIG. 1 shows the effects of drugs targeting the synthesis of VLCFAs on pathogenicity of Magnaporthe oryzae;

FIG. 2 shows the statistics of the number of necrotic lesions when drugs inhibit the pathogenicity of Magnaporthe oryzae;

FIG. 3 shows the statistics of the number of necrotic lesions when drugs inhibit the pathogenicity of Magnaporthe oryzae under prevention conditions; FIG. 4 shows the statistics of the number of necrotic lesions when drugs inhibit the pathogenicity of Magnaporthe oryzae under treatment conditions; FIG. 5 shows the effects of drugs on pathogenicity of corn pathogen Bipolaris maydis;

FIG. 6 shows the statistics of the number of disease spots when drugs inhibit the pathogenicity of corn pathogen Bipolaris maydis;

FIG. 7 shows the effects of drugs on pathogenicity of wheat pathogen Blumeria graminis;

FIG. 8 shows the disease index of drugs on inhibiting pathogenicity of wheat pathogen Blumeria graminis;

FIG. 9 shows that the drugs hinder the synthesis of VLCFAs of Magnaporthe oryzae;

FIG. 10 shows that the drugs synthesized by VLCFAs inhibit the formation of infection structure of Magnaporthe oryzae;

FIG. 11 shows the quantitative analysis of penetration peg formation of Magnaporthe oryzae;

FIG. 12 shows the schematic diagram of construction of MoELO knockout mutant;

FIG. 13 shows the PCR identification of ΔMoelo knockout mutant;

FIG. 14 shows the quantitative detection of VLCFAs in ΔMoelo knockout mutant;

FIG. 15 shows the pathogenicity analysis of ΔMoelo knockout mutant to rice;

FIG. 16 shows the analysis of the number of disease lesions after rice infected by ΔMoelo knockout mutant.

### DETAILED DESCRIPTION OF THE EMBODIMENTS

In order to make the purpose, technical scheme and advantages of the embodiments of the invention clearer, the technical scheme in the embodiments of the invention will be described clearly and completely below. If the specific conditions are not indicated in the Embodiments, they shall be carried out according to the conventional conditions or the conditions suggested by the manufacturer. The reagents or instruments used are conventional products that can be obtained through commercial purchase without indicating the manufacturer.

Unless otherwise defined herein, scientific and technical terms used in connection with the invention shall have the meanings commonly understood by those of ordinary skill in the art. Exemplary methods and materials are described below, but methods and materials similar or equivalent to those described herein can also be used in the invention.

Definitions:

As used herein, the term “pathogens” is a disease-causing microorganism, including bacteria, fungi, viruses, etc., which can produce pathogenic substances and cause host infection.

As used in the invention, the term “herbicide” refers to a drug that can completely or selectively kill weeds, also known as weedkiller, which is a kind of substance used to destroy or inhibit the growth of plants.

The features and performance of the invention will be further described in detail with Embodiments below.

### EMBODIMENTS

### Embodiment 1

Effects of drugs targeting the synthesis of VLCFAs on pathogenicity of pathogenic fungi.

1.1 Preparation and Application of Very Long Chain Fatty Acid Herbicides

Seven representative herbicides synthesized from VLCFAs are purchased for testing their effects on pathogenic growth of pathogenic fungi. The herbicide products are purchased from Sigma Company, including Molinate, Diallate, Metazachlor, Butachlor, Propachlor, Cafenstrole, Flufenacet, and the corresponding product numbers are 36171, PS507, 36155, 37887, 45637, 32430 and 31718, respectively. Dimethyl sulfoxide (DMSO) is used as the solvent, and all the drugs are dissolved to prepare mother liquor with a concentration of 500 mmol/L, which are stored at −20° C. for later use.

1.2 Cultivation of Pathogenic Fungi

The pathogenic fungus Magnaporthe oryzae used in our laboratory is Guy11, which is cultured in complete medium (CM for short). The strain of Bipolaris maydis is C56, which is cultured on potato medium (PDA). The Blumeria graminis strain is B. graminis f. sp.tritici, which is propagated in vivo by wheat. Metarhizium anisopliae strain is CQMa421 and cultured in ¼ glucose medium (¼ SDA for short). Preparation of above culture mediums:

(1) CM medium

10 g of anhydrous glucose, 2 g of peptone, 1 g of yeast extract, 1 g of casamino acids, 50 ml of 20× Nitrate Salts (nitrogen source), 1 ml of vitamin solution. Add ddH₂O (deionized water) into 1 ml of trace elements to 1000 ml, and adjust the pH value to 6.5 with 1 mol/L NaOH solution.

If solid culture medium needs to be prepared, add 15 g of agar powder into every 1000 ml of culture medium. Sterilization in damp-heat at 11° C. for 20 min.

The formula of 20× Nitrate Salts (nitrogen source) (1000 ml) is: 120 g of NaNO₃ (sodium nitrate), 10.4 g of KCl (potassium chloride), 10.4 g of MgSO₄.7H₂O (magnesium sulfate heptahydrate), 30.4 g of KH₂PO₄ (potassium dihydrogen phosphate), and add ddH₂O (deionized water) to 1000 ml, and sterilize in damp-heat at 121° C. for 20 min.

The formula of vitamin solution (1000 ml) is: 0.1 g of biotin, 0.1 g of pyridoxin, 0.1 g of thiamine, 0.1 g of riboflavin, 0.1 g of p-aminobenzoic acid (PABA), 0.1 g of nicotinic acid, and add ddH₂O to 1000 ml, filter and sterilize, and store in the dark at 4° C.

The formula of trace elements (100 ml) is: 2.2 g of ZnSO₄.7H₂O (zinc sulfate heptahydrate), 1.1 g of H₃BO₃ (boric acid), 0.5 g of MnCl₂.4H₂O (ammonium chloride tetrahydrate), 0.5 g of FeSO₄.7H₂O (ferrous sulfate heptahydrate), 0.17 g of CoCl₂.6H₂O (cobalt chloride hexahydrate), 0.16 g of CuSO₄.5H₂O (copper sulfate pentahydrate), 0.15 g of Na₂MoO₄.2H₂O (sodium molybdate dihydrate), add ddH₂O to 100 ml, filter and sterilize, and store in the dark at 4° C.

(2) PDA Culture Medium

200 g of peeled potato, 20 g of glucose, 15 g of agar, 1000 ml of distilled water, no need to adjust pH value. Cut potatoes into small pieces, add water and boil for 20-30 min until potatoes can be punctured by glass rods, filter potato residues with eight layers of gauze, collect the filtrate in a glass beaker, add 15 g of agar and 20 g of glucose, continue to heat, stir and mix evenly to dissolve them, then add distilled water to 1000 ml, sterilize at 121° C. for 20 min after sub-packaging, and store them for later use.

(3)¼ SDA Medium

10 g of glucose, 2.5 g of peptone, 5 g of yeast extract, if it is necessary to prepare solid medium, add 18 g of agar and distilled water 1000 ml, and adjust the pH value to 6.0. Dissolve all nutrients with distilled water while stirring, add distilled water to the final volume of 1000 ml, sub-pack, sterilize at 121° C. for 20 min, cool and store for later use.

1.3 Plants to be Tested

CO39, a commonly used rice variety with high susceptibility to rice blast, is used as the host material, and the rice leaves from seedling to three-leaf stage are used to detect the influence of drugs on the pathogenicity of rice blast. The maize variety is Zhenghong 505, and the leaves from seedling to five-leaf stage are used to detect the pathogenicity of Phytophthora infestans. Wheat Nannong 0686 is used as host material, and the leaves from seedling to three-leaf stage are used to detect the pathogenicity of Erysiphe cichoracearum.

1.4 Inoculation Method of Microbial Pathogens

1) Analysis of Pathogenicity of Magnaporthe oryzae

Collect conidia grown on CM plate for 10 days with sterilized distilled water, filter the bacterial suspension with Miracloth, centrifuge at 5000 rpm for 10 min to collect conidia, resuspend the conidia with 0.1% of Tween-20 solution until the final concentration of spore suspension is 1×10⁵/ml, and then add 500 mmol/L herbicide mother liquor to the final concentration of a suitable drug working solution. The spore suspension added with drugs is sprayed into rice plants, and the spore suspension containing 0.1% DMSO is sprayed as the control group. After spraying and inoculation, the rice is placed in an artificial climate room with 25° C., 12 h light/12 h dark alternation and 90% relative humidity. After 4-5 days, the necrotic spots on rice leaves are counted, and the number of necrotic spots on 5 cm² leaves is calculated.

2) Analysis of Pathogenicity of Bipolaris maydis

Collect conidia grown on the culture medium with sterilized distilled water, collect the conidia by centrifugation after filtration, re-suspend the conidia with 0.1% Tween −20 solution until the final concentration of spore suspension is 1×10⁵/ml, and then add the herbicide mother liquor to a suitable final concentration. The spore suspension is inoculated into corn leaves by spray inoculation. After spray inoculation, corn is placed in an artificial climate room. After 3-4 days, the number of disease spots on corn leaves is counted, and the number on 8 cm² leaf area is calculated.

3) Pathogenicity Analysis of Wheat Blumeria graminis

Put wheat leaves in a Petri dish, put a wet filter paper at the bottom to keep moisture, then spray the working liquid of medicine evenly on the wheat leaves, put it in a fume hood for 30 min to volatilize the moisture on the surface of the leaves, then gently shake off the spores of Blumeria graminis parasitically growing on the wheat leaves to the surface of the leaves, place them at 25° C. for heat preservation after inoculation, observe the incidence of the leaves after 4-5 days, and calculate the disease incidence area of Blumeria graminis on the leaves.

1.5 Inhibitory Effects of Drugs on Pathogenicity of Rice Blast Fungus Magnaporthe oryzae

(1) the Inhibitory Effect of Drugs on Pathogenicity of Magnaporthe oryzae

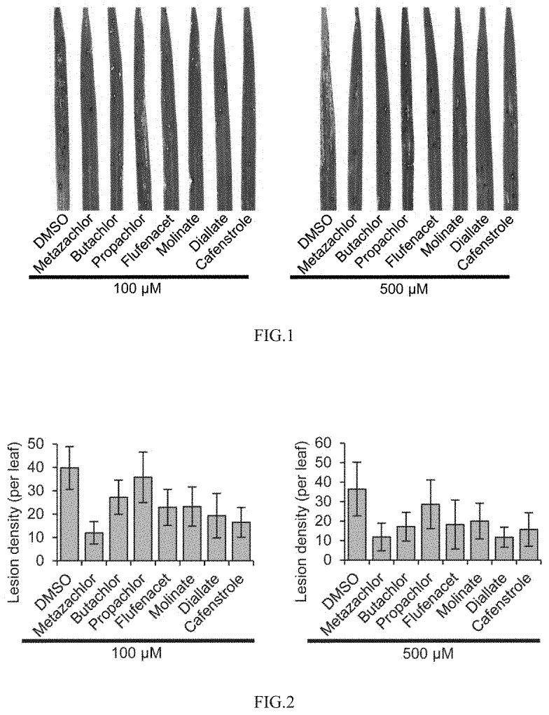

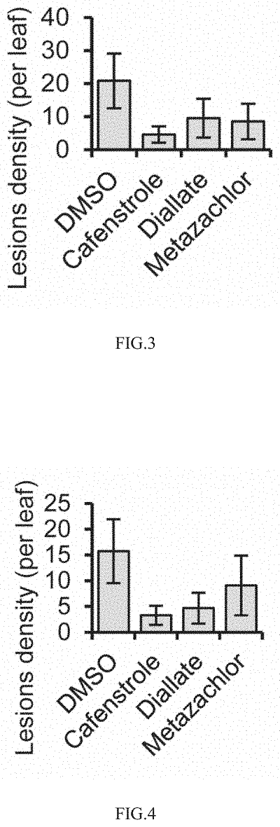

When Magnaporthe oryzae infects the host rice, the spore suspension added with DMSO is taken as the control without drug treatment, and at this time, Magnaporthe oryzae causes a large number of typical necrotic spots on rice leaves, but when the inhibitor drug of VLCFAs is added to the spore suspension, the number of necrotic spots decreases significantly (FIG. 1). By counting the number of diseased spots, it is found that when the drug concentration is 100 μM and 30 seedlings are sprayed with 5 mL of drugs, all drugs except Propachlor could inhibit the number of necrotic spots of Magnaporthe oryzae to a certain extent, and the inhibition rate of Metazachlor, Diallate and Cafenstrole on the number of necrotic spots is over 50% (FIG. 2). When the drug concentration is 500 μmol/L, the inhibition rate of Metazachlor, Butachlor, Diallate and Cafenstrole on the number of necrotic spots is over 50%. For plants, inhibitors targeting to inhibit VLCFAs have different inhibitory effects on different plants. Therefore, Propachlor may also have certain selectivity to pathogenic fungi, resulting in its insignificant inhibitory effect on rice blast. The above results indicate that various inhibitory drugs targeting the synthesis of VLCFAs could significantly inhibit the pathogenicity of Magnaporthe oryzae in the concentration range of 100-500 μmol/L.

The above results indicate that the three drugs, Cafenstrole, Metazachlor and Diallate, have a good inhibitory effect on rice blast. On this basis, the preventive and therapeutic effects of three inhibitory drugs on rice blast are further tested. At first, each drug with a concentration of 500 μmol/L is sprayed on rice seedlings, and only DMSO is sprayed as a control. After spraying for 8 h, the suspension of Magnaporthe oryzae is inoculated to rice seedlings to analyze the preventive effect of the inhibitor on rice blast. In addition, for rice seedlings, the suspension of Magnaporthe oryzae is inoculated to rice seedlings first, and after 8 h of inoculation, each drug with a concentration of 500 μmol/L is sprayed on the seedlings, while only DMSO is sprayed as a control group to analyze the therapeutic effect of the inhibitor on rice blast. After 4-5 days, the formation of necrotic spots of rice blast on rice leaves is observed, and it is found that both in the prevention experimental group (FIG. 3) or in the treatment experimental group (FIG. 4), compared with the solvent DMSO control, the three inhibitory drugs can significantly inhibit the formation of rice blast necrotic spots, and their inhibition rates can reach more than 50%. This result shows that a variety of inhibitory drugs targeting the synthesis of very-long-chain fatty acids have preventive and protective effects on rice blast.

(2) Inhibition of Drugs on Pathogenicity of Bipolaris maydis

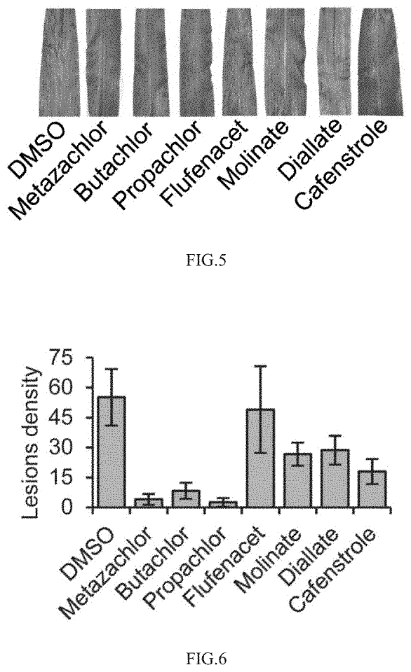

When the drug concentration is 500 μmol/L, it shows a more obvious inhibitory effect on the pathogenicity of Magnaporthe oryzae. Therefore, in subsequent experiments, the drug working solution concentration of 500 μmol/L is used to detect the pathogenicity to other pathogenic fungi. When further testing the influence of drugs on the pathogenicity of the pathogen, it is found that after inoculation of the pathogen in the solvent control DMSO group, a large number of disease spots are produced on the leaves of corn, while in the drug treatment group, all drugs except Flufenacet could inhibit the formation of disease spots to a certain extent (FIG. 5). The reason why the efficacy of Flufenacet is not obvious is because it has certain selectivity to the pathogen. By counting the number of disease spots, it is found that the inhibition rates of Propachlor, Metazachlor, Butachlor and Cafenstrole on the formation of disease spots are over 50% (FIG. 6).

(3) Inhibition of Drugs on Pathogenicity of Blumeria graminis Against Wheat

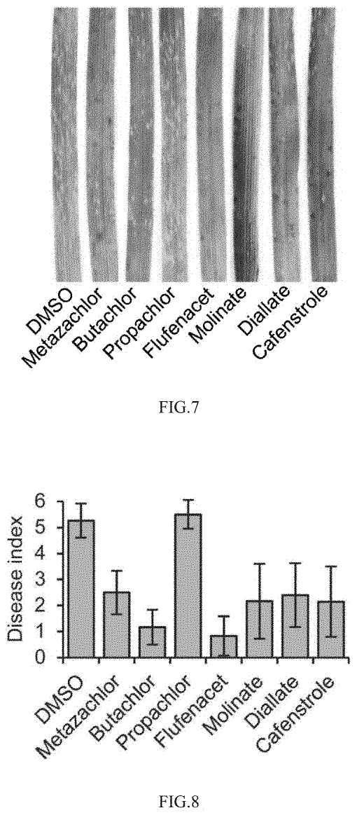

When examining the influence of drugs on the pathogenicity of Blumeria graminis in wheat, it is found that a large number of typical Blumeria graminis spots are produced on wheat leaves after inoculation of Blumeria graminis in the solvent control DMSO group, while in the drug treatment group, all drugs except Propachlor could inhibit the occurrence of Blumeria graminis disease spots (FIG. 7). The disease index of Blumeria graminis is calculated according to the method reported in the literature [Yang Gongqiang et al., Plant Protection, 2008,34(1):146-147], and all Metazachlor, Butachlor, Flufenacet, Molinate, Diallate and Cafenstrole are found to significantly inhibit the incidence of Blumeria graminis, with an inhibition rate of over 50% (FIG. 8).

### Embodiment 2

Drugs Hinder the Synthesis of VLCFAs from Magnaporthe oryzae

In order to analyze whether drugs hinder the pathogenicity of pathogenic fungi by inhibiting the synthesis of VLCFAs, three representative drugs, namely Metazachlor, Diallate and Cafenstrole, which have significant inhibitory effects on the pathogenicity of Magnaporthe oryzae, are selected to analyze the synthesis level of VLCFAs of Magnaporthe oryzae after their treatment.

2.1 Preparation of Magnaporthe oryzae Samples Treated with Drugs

Magnaporthe oryzae is cultured in liquid CM medium at 25° C. and 75 rpm for 2 days. Hyphae are collected and transferred to fresh liquid CM medium, and Metazachlor, Diallate and Cafenstrole are added to the hyphae medium respectively, with the final concentration of 500 μmol/L, and DMSO as the control without drug treatment. After adding drugs, culture for 24 h, and then collect hyphae for extracting lipid and analyzing fatty acid content.

2.2 Extraction and Quantitative Analysis of Fatty Acids

The extraction and quantification of fatty acids are carried out with reference to the chromatography-mass spectrometry tandem analysis method reported in the literature [Lam et al., Journal of Lipid Research, 2014 55: 299-306]. Chloroform:methanol (2:1) is added into the glass vial containing the liquid hyphae of Magnaporthe oryzae, and fatty acid d31-16:0 (Sigma) is added as an internal reference control for fatty acid quantification. Then shake violently at 4° C. for about half an hour, then centrifugally collect the lower organic phase liquid, transfer it to a new glass vial and dry it in vacuum. The extracted lipid samples are quantitatively analyzed by using the liquid chromatograph Exion UPLC system and the mass spectrometry system qtrap 6500 plus system (Sciex, Framingham, Mass.), in which fatty acids are separated by using the chromatographic column of Phenomenex Luna Silica 3 μm (i.d. 150 2.0 mm).

2.3 Fatty Acid Quantitative Analysis Results

The quantitative analysis of fatty acids (FIG. 9) shows that compared with DMSO, the contents of C16:0 and C18:0 in Magnaporthe oryzae do not change significantly, but the contents of fatty acids above C20 decrease, which indicates that the drugs have a significant inhibitory effect on the synthesis of VLCFAs in Magnaporthe oryzae.

### Embodiment 3

Drugs Hinder the Formation of Key Infection Structures of Magnaporthe oryzae

In order to analyze the reasons for the decrease of pathogenicity of Magnaporthe oryzae when drugs inhibit the synthesis of VLCFAs, the effects of Metazachlor, Diallate and Cafenstrole on the infection structure of Magnaporthe oryzae are further observed.

3.1 Microscopic Observation on Infection Structure of Magnaporthe oryzae

The leaf sheath of rice growing to 4-leaf stage is used as the material, and the transformed strain of Magnaporthe oryzae expressing cytoplasmic GFP is used for inoculation to facilitate microscopic observation of infection structure. The construction and using method of the strain refer to the reported method [Xu Youao et al., Plant Protection, 2017, 43(6):53-61], and the conidia suspension of Magnaporthe oryzae with the concentration of 1×10⁵/ml is prepared. At the same time, drugs are added to the spore suspension respectively until the final concentration is 500 μmol/L. Meanwhile, the spore suspension with DMSO as solvent is used as the control without drug treatment. The spore suspension is injected into the leaf sheath of rice and cultured at 25° C. After 24 h, the infection structure is observed microscopically.

3.2 Inhibitory Effect of Drugs on the Formation of Infected Nails

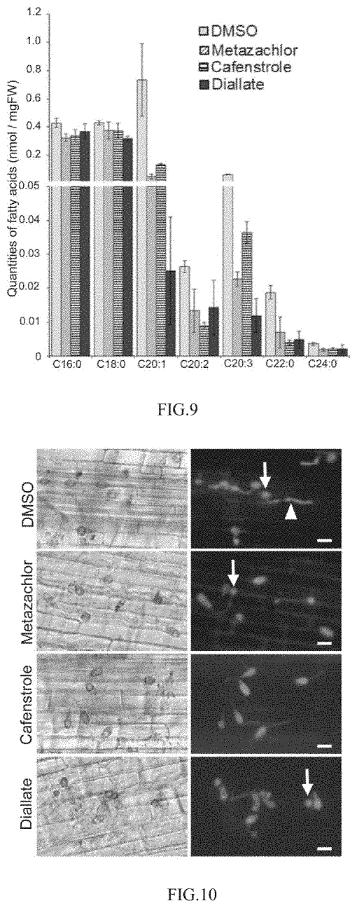

24 h after inoculation of rice leaf sheath, typical infection organ appressorium and penetration peg are produced by Magnaporthe oryzae in DMSO of control group. After drug treatment, although appressorium could be formed by Magnaporthe oryzae, the formation of penetration peg is hindered (FIG. 10). Quantitative analysis of the formation rate of infected nails shows that the three drugs had significant inhibitory effects on the formation of infected nails, and the inhibitory rate is over 50% (FIG. 11). The above results indicate that the formation of penetration pegs of Magnaporthe oryzae is blocked after targeted inhibition of the synthesis of VLCFAs by drugs, which results in the decrease of pathogenicity of Magnaporthe oryzae.

### Embodiment 4

MoELO, the key gene of VLCFAs synthesis in Magnaporthe oryzae, regulates pathogenicity.

4.1 Cloning of MoELO, a VLCFAs Elongase from Magnaporthe oryzae

VLCFAs synthesis pathway is highly conserved in eukaryotes, and VLCFAs elongase ELO is the rate-limiting enzyme of the synthesis pathway. Using yeast ELO protein sequence for homology comparison, the Magnaporthe oryzae homologous protein MoELO is identified from the Magnaporthe oryzae genome database. To further identify the MoELO protein sequence of Magnaporthe oryzae, the full cDNA sequence of MoELO is cloned from the cDNA of wild-type strain Guy11 of Magnaporthe oryzae by using Phusion high fidelity enzyme (item number F530S) of Thermo Fisher Company and primer pair ELO-For/ELO-Rev (sequences of the primers ELO-For and ELO-Rev are respectively shown in SEQ ID NO: 1 and SEQ ID NO: 2, Primers synthesis are completed by Shanghai Shenggong Bioengineering Co., Ltd.), and it is connected to pEASY-Blunt vector and sequenced (the sequencing is completed by Shanghai Shenggong Bioengineering Co., Ltd.).

PCR amplification system (50 μl) is as follows: 0.5 μl (50 ng) of Guy11 strain cDNA, 0.5 μl (2 U/μl) of Phusion DNA polymerase, 10 μl of 5× Phusion HF buffer, 1 μl of dNTP (25 mmol/L, each kind), and 0.5 μl of upstream primer (50 μmol/l), 0.5 μl of downstream primer (50 μmol/l) and 37 μl of ddH₂O.

PCR amplification procedure: pre-denaturation at 98° C. for 30 s; 10 s at 98° C., 30 s at 60° C., and 72° C. for 1 min, for 35 cycles; at 72° C. for 10 min, and heat preservation at 4° C.

4.2 Construction of MoELO Gene Knockout Mutant of Magnaporthe oryzae

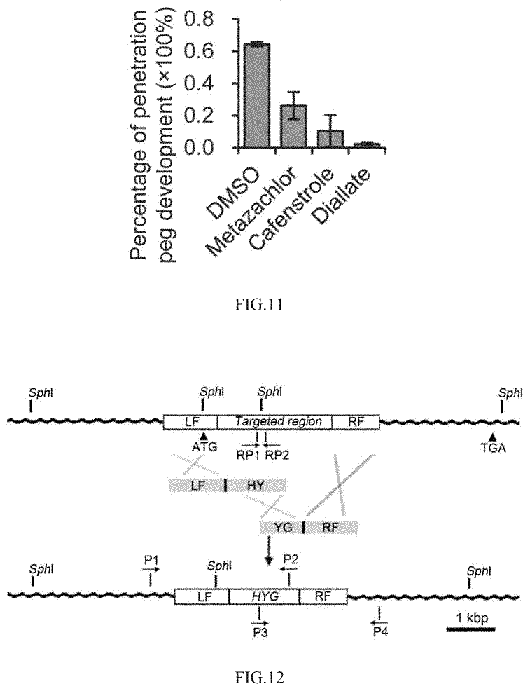

A knockout mutant of MoELO is constructed by using the Split-Marker gene knockout method described in the literature [Kershaw et al., P. Natl. Acad. Sci. USA, 2009, 106(37):15967-15972], and its schematic diagram is shown in FIG. 12. The coding sequence of about 1 kbp of MoELO gene is selected as the targeted region. In the process of gene knockout, homologous recombination event replaces the targeted region sequence with hygromycin screening marker gene HYG, thus forming a gene knockout mutant.

The specific construction steps are as follows: using Guy11 genome as template, using Phusion high fidelity enzyme and primer pairs ELO-LF-For/ELO-LF-Rev (sequences of the primers ELO-LF-For and ELO-LF-Rev are respectively shown in SEQ ID NO: 3 and SEQ ID NO: 4) and ELO-RF-For/ELO-RF-Rev (sequences of the primers ELO-RF-For and ELO-RF-Rev are respectively shown in SEQ ID NO: 5 and SEQ ID NO: 6), respectively, the left-wing LF and right-wing RF fragments of MoELO with a length of 1 kbp are amplified by PCR. The sequences of primers are shown in Table 1.

PCR amplification system (50 μl) is as follows: 0.5 μl (100 ng) of Guy11 genomic DNA, 0.5 μl (5 U/μl) of Phusion DNA polymerase, 10 μl of 5× Phusion HF buffer, 0.5 μl of dNTP (25 mmol/L, each kind), and 0.5 μl of upstream primer (50 μmol/l), 0.5 μl of downstream primer (50 μmol/l) and 37 μl of ddH₂O.

PCR amplification procedure: pre-denaturation at 94° C. for 5 min; at 94° C. for 30 s, 58° C. for 30 s and 72° C. for 1 min, for 35 cycles; 10 min at 72° C. and heat preservation at 4° C.

Two fragments HY and YG of hygromycin screening marker gene HYG are amplified with primer pairs HYG-For/HY-split (sequences of the primers HYG-For and HY-split are respectively shown in SEQ ID NO: 7 and SEQ ID NO: 8) and YG-split/HYG-Rev (sequences of the primers YG-split and HYG-Rev are respectively shown in SEQ ID NO: 9 and SEQ ID NO: 10), respectively, and the two fragments are 1.1 kbp and 730 bp in size.

The primer sequences of HYG-For/HY-split and YG-split/HYG-Rev are shown as Table 1.

PCR amplification system (50 μl) is as follows: 0.5 μl (10 ng) of pCB1004 plasmid template, 0.5 μl (5 U/μl) of Phusion DNA polymerase, 10 μl of 5× Phusion HF buffer, 0.5 μl of dNTP (25 mmol/L, each kind), and 0.5 μl of upstream primer (50 μmol/l), 0.5 μl of downstream primer (50 μmol/l) and 37 μl of ddH₂O.

PCR amplification procedure: pre-denaturation at 94° C. for 5 min; 94° C. for 30 s, 58° C. for 30 s, 72° C. for 1 min and 30 s, for 35 cycles; 10 min at 72° C. and heat preservation at 4° C.

The four amplified fragments LF, RF, HY and YG are recovered by agarose gel electrophoresis. The fragments LF and HY are connected by using the primer pair ELO-LF-For/HY-split to form a fusion fragment LF-HY; meanwhile, a primer pair YG-split/ELO-RF-Rev is used to link the fragment YG and RF to form a fusion fragment YG-RF.

PCR reaction system (50 μl) for obtaining fusion fragments LF-HY and YG-RF is as follows: 1 μl (about 50 ng) of upstream fragment, 1 μl (about 50 ng) of downstream fragment, 0.5 μl (5 U/μl) of Phusion DNA polymerase, 10 μl of 5× Phusion HF buffer, dNTP (25 mmol/L, each kind), and 0.5 μl of upstream primer (50 μmol/l), 0.5 μl of downstream primer (50 μmol/l) and 36 μl of ddH₂O.

PCR amplification procedure: 94° C. for 5 min; at 94° C. for 30 s, 58° C. for 30 s and 72° C. for 1 min and 30 s, for 35 cycles; 10 min at 72° C. and heat preservation at 4° C.

The DNA fragments LF-HY and YG-RF are recovered by agarose gel electrophoresis. Meanwhile, the protoplasts of Guy11, a wild-type strain of Magnaporthe oryzae, are prepared according to the methods described in previous literatures [Tablot et al., The Plant Cell, 1993, 5: 1575-1590]. The LF-HY and YG-RF fragments are co-transferred into the protoplasts, and the fungal transformants are screened by CM plate containing hygromycin. In the process of gene replacement shown in FIG. 12, homologous replacement occurs because the LF and RF sequences of the fusion fragment are homologous to the site sequence of MoELO on the genome.

4.3 Identification of MoELO Knockout Mutant δ Moelo

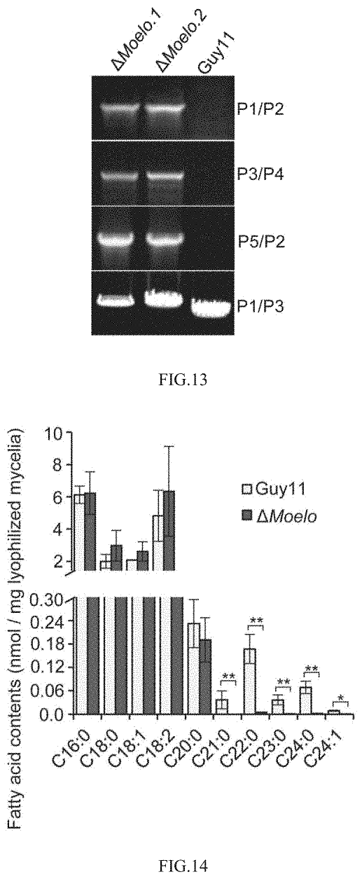

A total of 80 transformants are obtained in the experiment. After extracting the genomic DNA of the transformants, PCR verification is carried out by using primer pairs P1/P2 and P3/P4 (sequences of the primers P1, P2, P3, P4 are respectively shown in SEQ ID NO: 11, SEQ ID NO: 12, SEQ ID NO: 13 and SEQ ID NO: 14). The randomly inserted fragments could not produce amplification bands, but only the transformants with homologous substitution at MoELO gene site could produce amplification bands. After PCR detection, the two transformants are knock-out mutants produced by homologous substitution (FIG. 13), and their numbers are ΔMoelo.1 and ΔMoelo.2, respectively.

PCR reaction system (25 μl) for detecting transformants is: 0.5 μl (50 ng) of transformant genomic DNA, 0.3 μl (5 U/μl) of Taq polymerase, 2.5 μl of 10× buffer (+MgCl₂, 25 mmol/l), and 0.2 μl of dNTP (25 mmol/L, each kind), and 0.2 μl of upstream primer (50 μmol/l), 0.2 μl of downstream primer (50 μmol/l) and 21.1 μl of ddH₂O. PCR amplification procedure: pre-denaturation at 94° C. for 5 min; at 94° C. for 30 s, 58° C. for 30 s and 72° C. for 2.5 min, for 35 cycles; 10 min at 72° C. and heat preservation at 4° C.

4.4 Quantitative Analysis of Super Long Chain Fatty Acids in Knockout Mutant δ ΔMoelo.

According to previous research reports [Lam et al., Journal of Lipid Research, 2014, 55: 299-306], the content of VLCFAs in Magnaporthe oryzae is analyzed by liquid chromatography and mass spectrometry, and it is found that the content of VLCFAs with carbon chain number greater than 20 in knockout mutant ΔMoelo is significantly lower than that of wild-type strain Guy11 (FIG. 14). Therefore, MoELO gene plays an important role in the synthesis of VLCFAs of Magnaporthe oryzae.

4.5 Testifying Regulation of MoElo Gene on Pathogenicity of Magnaporthe oryzae.

According to the following method:

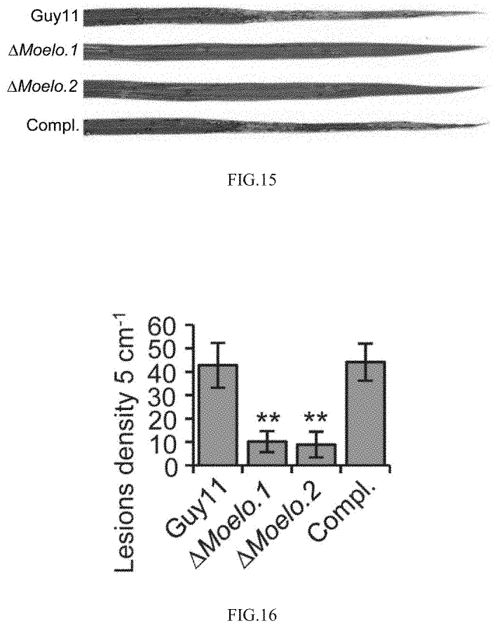

At 25° C., the wild-type strain Guy11 of Magnaporthe oryzae and the knockout mutant ΔMoelo grow on the CM plate for 10 days, and then the conidia on the plate are scraped with sterile distilled water containing 0.1% Tween -20 to prepare a spore suspension with a concentration of 1×10⁵ spores/ml. Taking CO39, a rice variety commonly used in laboratory with high susceptibility to rice blast (which is stored in Rice Research Institute of Sichuan Agricultural University), as the host material, the spore suspension is inoculated on the leaves of rice which had been bred for 21 days. Five days after inoculation, the disease of rice leaves is observed (FIG. 15), and it is found that wild-type strains cause a large number of typical rice blast spots on rice leaves, while the number of disease spots formed on rice leaves decreased significantly after inoculation of knock-out mutant ΔMoelo (FIG. 16), which indicates that MoELO plays a key role in regulating the pathogenicity of Magnaporthe oryzae.

The above description is only some embodiments of the invention, and is not used to limit the invention. For those skilled in the art, the invention can be modified and varied. Any modification, equivalent substitution, improvement, etc. made within the spirit and principle of the invention shall fall in the protection scope of the invention.

### INDUSTRIAL PRACTICABILITY

The invention provides an application of compounds inhibiting the synthesis of VLCFAs in preventing and treating pathogenic bacteria, which provides a new idea or strategy for preventing and treating plant diseases such as pathogen infection, and also provides more choices for the types of drugs for preventing and treating plant diseases.

What is claimed is:

1. An application method of a compound inhibiting synthesis of very long chain fatty acids (VLCFAs), wherein the compound is applied in preventing and controlling microbial pathogens.

2. The application method according to claim 1, wherein each of the VLCFAs is a fatty acid with a carbon chain length of more than 20 carbon atoms.

3. The application method according to claim 2, wherein the compound is selected from the group consisting of a thiocarbamate compound and an amide compound.

4. The application method according to claim 3, wherein the thiocarbamate compound is selected from the group consisting of Molinate, Diallate, Pebulate, Butylate, Sulfallate, and Trialater and combinations thereof.

5. The application method according to claim 3, wherein the amide compound is selected from the group consisting of Metazachlor, Butachlor, Propachlor, Cafenstrole, Flufenacet, Acetochlor, and Metolachlor and combinations thereof.

6. The application method according to claim 1, wherein the microbial pathogens are pathogenic fungi, and the pathogenic fungi are plant pathogenic fungi selected from the group consisting of Magnaporthe oryzae, Bipolaris maydis and Blumeria graminis.

7. The application method according to claim 1, wherein the microbial pathogens are animal pathogenic fungi, and the animal pathogenic fungi are Metarhizium anisopliae.

8. The application method according to claim 1, wherein
the compound is selected from the group consisting of Metazachlor, Butachlor, Diallate, and Cafenstrole and combinations thereof, when the microbial pathogens are Magnaporthe oryzae;
the compound is selected from the group consisting of Propachlor, Metazachlor, Butachlor, and Cafenstrole and combinations thereof, when the microbial pathogens are Bipolaris maydis;
the compound is selected from the group consisting of Metazachlor, Butachlor, Flufenacet, Molinate, Diallate, and Cafenstrole and combinations thereof, when microbial pathogens are Blumeria graminis.

9. A method for preventing microbial pathogens, wherein the method comprises:
applying a compound having a property of inhibiting synthesis of very long chain fatty acids (VLCFAs) to an object to be prevented; and each of the VLCFAs is a fatty acid with a carbon chain length of more than 20 carbon atoms.

10. The method according to claim 9, wherein the compound is selected from the group consisting of a thiocarbamate compound and an amide compound.

11. The method according to claim 10, wherein the thiocarbamate compound is selected from the group consisting of Molinate, Diallate, Pebulate, Butylate, Sulfallate, and Trialater and combinations thereof; and
the amide compound is selected from the group consisting of Metazachlor, Butachlor, Propachlor, Cafenstrole, Flufenacet, Acetochlor, and Metolachlor and combinations thereof.

12. The method according to claim 9, wherein the microbial pathogens are pathogenic fungi selected from the group consisting of Magnaporthe oryzae, Bipolaris maydis and Blumeria graminis;
wherein the object to be prevented is a plant selected from the group consisting of rice, corn, and wheat; and
wherein:
the compound is selected from the group consisting of Metazachlor, Butachlor, Diallate, and Cafenstrole and combinations thereof, when the pathogenic fungi are the Magnaporthe oryzae;
the compound is selected from the group consisting of Propachlor, Metazachlor, Butachlor, and Cafenstrole and combinations thereof, when the pathogenic fungi are the Bipolaris maydis;
the compound is selected from the group consisting of Metazachlor, Butachlor, Flufenacet, Molinate, Diallate, and Cafenstrole and combinations thereof, when the pathogenic fungi are the Blumeria graminis.

13. The method according to claim 12, wherein an effective control dose of the compound is as follows: 1-2 g of the compound is sprayed in every 100 m² target area.

14. The method according to claim 13, wherein the compound is sprayed in the following manner: 1-2 g of the compound is dissolved in 4 mL of dimethyl sulfoxide, then the compound dissolved in dimethyl sulfoxide is dissolved in 2 L of water to obtain an aqueous solution, a final concentration of the compound is 500-1000 μmol/L in the aqueous solution, and the aqueous solution is sprayed on the target area.

15. The method according to claim 14, wherein the target area refers to a planting area where crops are cultivated for fungal prevention.

16. The method according to claim 15, wherein the compound is administered at a concentration of 500 μmol/L.

17. A method for preventing pathogenic bacteria, comprising:
1) preparing a compound with characteristic of inhibiting synthesis of VLCFAs into a solution to be applied;
2) applying the solution to a subject to be controlled.

18. The method according to claim 17, wherein dimethyl sulfoxide is used as a solvent.

19. The method according to claim 17, wherein
the compound is selected from the group consisting of Metazachlor, Butachlor, Diallate, and Cafenstrole and combinations thereof, when the pathogenic bacteria are the Magnaporthe oryzae;
the compound is selected from the group consisting of Propachlor, Metazachlor, Butachlor, and Cafenstrole and combinations thereof, when the microbial pathogens are the Bipolaris maydis;
the compound is selected from the group consisting of Metazachlor, Butachlor, Flufenacet, Molinate, Diallate, and Cafenstrole and combinations thereof, when the pathogenic bacteria are the Blumeria graminis;
and wherein each of the VLCFAs is a fatty acid with a carbon chain length of more than 20 carbon atoms.


SEQUENCE LISTING (14 sequences)

SEQ ID NO: 1 - DNA, 25 bp, Artificial Sequence
  primer ELO-For
atggcggaaatactagacaagatcc

SEQ ID NO: 2 - DNA, 26 bp, Artificial Sequence
  primer ELO-Rev
cgccttgcgagagcgaggggtcgacg

SEQ ID NO: 3 - DNA, 18 bp, Artificial Sequence
  primer ELO-LF-For
aaattgacgacgagaccg

SEQ ID NO: 4 - DNA, 41 bp, Artificial Sequence
  primer ELO-LF-Rev
gtcgtgactgggaaaaccctggcgaactccctgccaccaaa

SEQ ID NO: 5 - DNA, 46 bp, Artificial Sequence
  primer ELO-RF-For
tcctgtgtgaaattgttatccgctagaccaaagaaacccaataact

SEQ ID NO: 6 - DNA, 18 bp, Artificial Sequence
  primer ELO-RF-Rev
tgacctcccgacaactgc

SEQ ID NO: 7 - DNA, 20 bp, Artificial Sequence
  primer HYG-For
gtcgacagaagatgatattg

SEQ ID NO: 8 - DNA, 20 bp, Artificial Sequence
  primer HY-split
cgttgcaagacctgcctgaa

SEQ ID NO: 9 - DNA, 24 bp, Artificial Sequence
  primer YG-split
agcggataacaatttcacacagga

SEQ ID NO: 10 - DNA, 23 bp, Artificial Sequence
  primer HYG-Rev
ttactattcctttgccctcggac

SEQ ID NO: 11 - DNA, 20 bp, Artificial Sequence
  primer P1
gaaagtttgtgggaggaagg

SEQ ID NO: 12 - DNA, 22 bp, Artificial Sequence
  primer P2
gcttctgcgggcgatttgtgta

SEQ ID NO: 13 - DNA, 19 bp, Artificial Sequence
  primer P3
gagagaacaagacgcatac

SEQ ID NO: 14 - DNA, 18 bp, Artificial Sequence
  primer P4
cggacaatggccgcataa